(19) United States
(12) Patent Application Publication
(10) Pub. No.: US 2023/0076198 A1
(43) Pub. Date: Mar. 9, 2023

(54) SYSTEM FOR MONITORING RADIATION BASED ON MONITORING POST

(71) Applicant: FNC TECHNOLOGY CO., LTD., Yongin-si (KR)

(72) Inventors: Sang Hun SHIN, Yongin-si (KR); Hee Kwon KU, Hwaseong-si (KR); Beom Kyu KIM, Hwaseong-si (KR); Min Beom HEO, Yongin-si (KR)

(73) Assignee: FNC TECHNOLOGY CO., LTD., Yongin-si (KR)

(21) Appl. No.: 17/852,433

(22) Filed: Jun. 29, 2022

(30) Foreign Application Priority Data
Sep. 7, 2021 (KR) 10-2021-0118844
Sep. 7, 2021 (KR) 10-2021-0118845

(51) Int. Cl. G01V 5/00; G01T 1/29; G05D 1/00; G05D 1/10; G05D 1/04

(52) U.S. Cl. CPC G01V 5/0083; G01T 1/2914; G01V 5/0091; G05D 1/0094; G05D 1/104; G05D 1/042

(57) ABSTRACT

Provided is a system for monitoring radiation based on a monitoring post, the system implemented to perform aerial radiation measurement for the altitude in the vertical direction based on the location in which monitoring posts are installed, thereby efficiently predicting the movement path and the contaminated area of radioactive materials, and efficiently distinguishing radioactive leakage from the ground surface and radioactive materials that float and move from the outside.

### CROSS-REFERENCE TO RELATED APPLICATION(S)

This application claims priority from Korean Patent Application No. 10-2021-0118844 and 10-2021-0118845, filed on Sep. 7, 2021, in the Korean Intellectual Property Office, the disclosure of which is incorporated herein by reference in its entirety.

### BACKGROUND

### 1. Field

The following description relates to a technology of measuring radiation, and more specifically, to a system for monitoring radiation based on a monitoring post.

### 2. Description of Related Art

Currently, environmental radioactivity monitoring in Korea mostly relies on monitoring posts installed at a height of 1 m to 2 m from ground level at intervals of 1 km to 5 km within a radius of 50 km from a nuclear power plant.

A monitoring post is operated using a high-pressure ionization chamber (HPIC) type ambient gamma dosimeter and a gamma-ray spectrum monitor using a scintillation detector (NaI (Tl)) installed at a height of 1 m to 2 m from ground level, and according to the purpose for detecting human exposure, performing measurement at human heights.

In the event of a serious nuclear accident, measuring radioactive materials transferred from radioactive plume containing fine dust, ultrafine dust, and aerosols is one of the factors of uncertainty, and since objects to be measured mostly travel long distances, the objects float at high altitudes before falling to the ground.

Therefore, it is necessary to find information about the movement route of radioactive plume, radioactivity (dose), etc. and prepare for damage in advance. However, since it is difficult to acquire data on aerial radiation using only monitoring posts, aerial radiation survey technologies using unmanned aerial vehicles (UAVs) have emerged.

Korean Registered Patent No. 10-2057189 (Dec. 12, 2019) discloses a method of detecting radioactive materials using a UAV. In the technology, when a UAV is flying in the air, a radiation meter mounted on the UAV measures the radiation dose while rotating at a constant rotation speed. When the measured radiation dose exceeds a certain standard radiation counting rate, the UAV moves in a specific direction in which the radiation dose is measured, and upon arrival at a place in which radioactive materials are located, the UAV transmits its current location information, and thus the location of the radioactive materials is detected.

Meanwhile, Korean Unexamined Patent Application Publication No. 10-2016-0045356 (Apr. 7, 2016) discloses a system for controlling a UAV and a method of detecting radiation using a UAV for detecting radiation. The technology involves setting a radiation detection zone based on an atmospheric diffusion impact assessment result and an emergency planning zone (EPZ), and putting a UAV in the set radiation detection zone to perform radiation detection. The UAV performing radiation detection adjusts the moving path through communication between UAVs to increase the number of UAVs put in a zone having a high level of radiation to thereby perform rapid and precise radiation detection in the case of radiation leakage.

Meanwhile, Korean Registered Patent No. 10-0946738 (Mar. 3, 2010) discloses a mobile radiation dosimeter using a plurality of semiconductor radiation sensors. The technology includes a plurality of semiconductor radiation sensors arranged such that signal extraction electrode surfaces thereof face in different directions and a signal processor for collecting and analyzing signals output from the plurality of semiconductor radiation sensors, so that not only the radiation dose and the type of radioactive isotopes but also the direction in which the radioactive isotope is located may be effectively determined.

However, while such conventional techniques are effective in identifying the location of radioactive materials, a method of predicting the movement path and diffusion status of radioactive materials transferred from floating particles in the air, in particular, from the plume including fine dust, ultrafine dust, aerosols, etc. that are generated in the event of a serious nuclear accident, has not been proposed. In particular, a concept of providing data for distinguishing radioactivity leakage from the ground surface and radioactive materials that float and move from the outside has not been seen.

Therefore, the present inventor has conducted studies on a technology for efficiently predicting the movement path and the contaminated area of radioactive materials, and efficiently distinguishing radioactive leakage from the ground surface and radioactive materials that float and move from the outside, by performing aerial radiation measurement for the altitude in the vertical direction based on the locations in which monitoring posts are installed.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

The following description relates to a system for monitoring radiation based on a monitoring post, capable of performing aerial radiation measurement for the altitude in the vertical direction based on the locations in which monitoring posts are installed, thereby efficiently predicting the movement path and the contaminated area of radioactive materials, and efficiently distinguishing radioactive leakage from the ground surface and radioactive materials that float and move from the outside.

The following description relates to a system for monitoring radiation based on a monitoring post, which is implemented to vary the distance between radiation detectors included in an aerial radiation analyzer of a radiation monitoring unmanned aerial vehicle (UAV) and installed in multiple directions, thereby minimizing the effect of interference of radiation signals incident on the radiation detectors.

In one general aspect, a system for monitoring radiation based on a monitoring post includes: a plurality of monitoring posts each installed at one position of a plurality of positions for monitoring radiation to detect terrestrial radiation at the respective position; and at least one radiation monitoring unmanned aerial vehicle (UAV) provided for each of the plurality of monitoring posts to detect aerial radiation at each measurement altitude vertically above the monitoring post.

The radiation monitoring UAV may include: an automatic flight control system configured to control flight of the radiation monitoring UAV so that the radiation monitoring UAV ascends to the measurement altitude every measurement period; an aerial radiation analyzer configured to detect aerial radiation in at least four azimuth directions for each measurement altitude, and analyze and collect nuclides of the aerial radiation in each of the at least four azimuth directions for each measurement altitude; a memory configured to store a result of analyzing the nuclides of the aerial radiation in each azimuth direction for each measurement altitude output by the aerial radiation analyzer; and a control unit configured to control drive of the automatic flight control system every measurement period and control the result of analyzing the nuclides of the aerial radiation in each azimuth direction for each measurement altitude collected by the aerial radiation analyzer to be stored in the memory.

The radiation monitoring UAV may further include a Global Positioning System (GPS) module configured to calculate a current location, wherein the automatic flight control system may be configured to use the current position calculated by the GPS module to control the flight to prevent the radiation monitoring UAV from departing from a position vertically above the monitoring post.

The control unit may be configured to control the result of analyzing the nuclides of the aerial radiation in each azimuth direction for each measured altitude to be stored in the memory in association with the current position calculated by the GPS module.

The radiation monitoring UAV may further include an altimeter configured to measure an altitude of the radiation monitoring UAV; and the automatic flight control system may be configured to use altitude data measured by the altimeter to control the flight so that the radiation monitoring UAV ascends to the measurement altitude and maintains the measurement altitude for a measurement time.

The radiation monitoring UAV may further include an azimuth sensor configured to measure an azimuth, and the automatic flight control system may be configured to use the azimuth measured by the azimuth sensor to control the flight so that the aerial radiation analyzer maintains a constant azimuth direction.

The aerial radiation analyzer may include: a plurality of radiation detectors installed in at least four azimuth directions to detect aerial radiation in respective azimuth directions for each measured altitude; a plurality of nuclide analyzers each configured to analyze nuclides of aerial radiation in a respective one of the at least four azimuth directions for each measurement altitude detected by a respective one of the plurality of radiation detectors; and a data acquisition system (DAS) configured to collect results of analyzing nuclides of aerial radiation in each of the at least four azimuth directions for each measurement altitude, which are analyzed by each of the plurality of nuclide analyzers.

The aerial radiation analyzer may further include: a plurality of variable units configured to vary the plurality of radiation detectors and the plurality of nuclide analyzers in the respective azimuth directions to prevent radiation signal interference when detecting radiation in the respective azimuth directions; and the control unit may be configured to control drive of the plurality of variable units to detect radiation in the respective azimuth directions.

The radiation detector may be further installed in a downward direction to further detect radiation in the downward direction.

The aerial radiation analyzer may further include a plurality of flexible connector cables each configured to transmit, to the control unit, the result of analyzing the nuclides output from a respective one of a plurality of nuclide analyzers that are variable in respective azimuth directions of the at least four azimuth directions without interruption.

The radiation monitoring UAV may further include a first wireless communication unit configured to wirelessly transmit the result of analyzing the nuclides of the aerial radiation in each azimuth direction for each measurement altitude stored in the memory.

The monitoring post may include a terrestrial radiation analyzer configured to detect terrestrial radiation every measurement period, analyze nuclides of the detected terrestrial radiation, and collect the analyzed terrestrial radiation; a second wireless communication unit configured to wirelessly transmit a synchronization signal to the radiation monitoring UAV every measurement period and wirelessly receive the result of analyzing the nuclides of the aerial radiation in each azimuth direction for each measurement altitude from the radiation monitoring UAV; and an integrated control unit configured to integrate and manage a result of analyzing the nuclides of the terrestrial radiation collected by the terrestrial radiation analyzer and the result of analyzing the nuclides of the aerial radiation in each azimuth direction for each measurement altitude received through the second wireless communication unit.

The system may further include a central control server configured to collect results of detecting terrestrial radiation and results of analyzing nuclides of aerial radiation in each azimuth direction for each measurement altitude from the plurality of monitoring posts, and analyze the collected results to estimate a movement path and a contaminated area of radioactive materials.

Other features and aspects will be apparent from the following detailed description, the drawings, and the claims.

### BRIEF DESCRIPTION OF THE DRAWINGS

FIG. 1 is a schematic diagram illustrating a system for monitoring radiation based on a monitoring post according to the present invention.

FIG. 2 is a block diagram illustrating a configuration of a radiation monitoring unmanned aerial vehicle (UAV) of a system for monitoring radiation based on a monitoring post according to an embodiment of the present invention.

FIG. 3 is a block diagram illustrating a configuration of an aerial radiation analyzer provided in a radiation monitoring UAV of a system for monitoring radiation based on a monitoring post according to an embodiment of the present invention.

FIG. 4 is a diagram illustrating an example in which an aerial radiation analyzer of a variable structure is mounted on a radiation monitoring UAV.

FIG. 5 is a diagram for describing a variable structure of an aerial radiation analyzer provided in a radiation monitoring UAV of a system for monitoring radiation based on a monitoring post according to the present invention.

FIG. 6 is a diagram illustrating an aerial radiation analyzer provided in a radiation monitoring UAV of a system for monitoring radiation based on a monitoring post according to another embodiment of the present invention.

FIG. 7 is a block diagram illustrating a configuration of a monitoring post of a system for monitoring radiation based on a monitoring post according to an embodiment of the present invention.

Throughout the accompanying drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

Hereinafter, various embodiments of the present invention will be described in detail with reference to the accompanying drawings in order to enable those skilled in the art to easily understand and practice the present invention. While specific embodiments are shown by way of example in the accompanying drawings and described in the specification, there is no intention to limit the present disclosure to the particular embodiments disclosed.

In the description of the embodiments, the detailed description of related known functions or constructions will be omitted herein to avoid making the subject matter of the present invention unclear.

It should be understood that, when an element is referred to as being “connected to” or “coupled to” another element, the element can be directly connected or coupled to another element, or an intervening element may be present. Conversely, when an element is referred to as being “directly connected to” or “directly coupled to” another element, there are no intervening elements present.

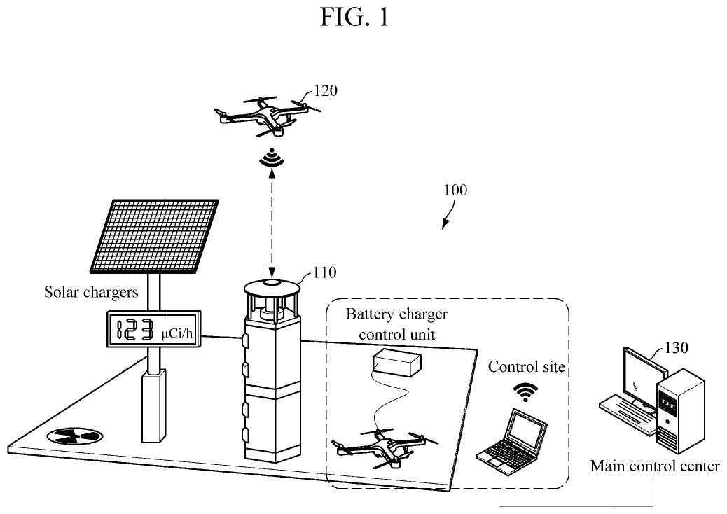

FIG. 1 is a schematic diagram illustrating a system for monitoring radiation based on a monitoring post according to the present invention. Referring to FIG. 1, a system 100 for monitoring radiation based on a monitoring post according to the present invention includes a plurality of monitoring posts 110 and a plurality of radiation monitoring unmanned aerial vehicles (UAVs) 120.

The monitoring posts 110 are installed at respective positions for monitoring radiation and detect terrestrial radiation at the respective installation positions. For example, the monitoring posts 110 may be installed at a height of 1 m to 2 m from ground level at intervals of 1 km to 5 km within a radius of 50 km from a nuclear power plant to detect terrestrial radiation having a risk of human exposure.

At least one radiation monitoring UAV 120 is provided for each of the monitoring posts 110 to detect aerial radiation for each measurement altitude vertically above the monitoring post 110. For example, the radiation monitoring UAV 120 may be implemented to, while ascending vertically to each measurement altitude above the monitoring post 110, every measurement period, detect aerial radiation in at least four azimuth directions at each measurement altitude, and analyze nuclides of the detected aerial radiation.

In this case, a single radiation monitoring UAV 120 may be operated for each of the monitoring posts 110, but in order to measure aerial radiation at the measurement altitude, the radiation monitoring UAV 120 needs to fly while maintaining the measurement altitude for a long time, and thus the battery consumption for supplying power to the radiation monitoring UAV 120 is significant. Accordingly, two or more radiation monitoring UAVs 120 may be operated for each of the monitoring posts 110.

Results of measuring terrestrial radiation detected by the monitoring posts 110 installed at a plurality of locations, and results of measuring aerial radiation in four azimuth directions at each altitude detected by the radiation monitoring UAVs 120 flying up and down in the air vertically above the respective monitoring posts 110 are collected for each measurement time zone and analyzed based on meteorological environmental conditions for each measurement time zone, such as wind direction, wind speed, atmospheric temperature, precipitation, and the like, thereby predicting the movement path and the contaminated area of radioactive materials.

When implemented according to the present invention as described above, aerial radiation measurement for the altitude can be performed in the vertical direction based on the locations in which monitoring posts are installed, so that the movement path and the contaminated area of radioactive materials can be efficiently predicted, and radioactive leakage of the ground surface and radioactive materials that float and move from the outside can be efficiently distinguished, and thus the risk of radiation exposure can be prepared for in advance.

In addition, according to the present invention, since early prediction of a nuclear accident is possible through monitoring of a radioactive material movement path, radiation exposure of residents may be prevented by issuing an alarm for evacuation of residents.

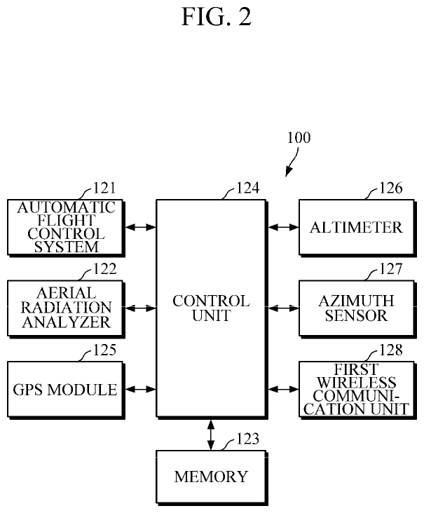

FIG. 2 is a block diagram illustrating a configuration of a radiation monitoring UAV of a system for monitoring radiation based on a monitoring post according to an embodiment of the present invention. Referring to FIG. 2, the radiation monitoring UAV 120 according to the embodiment includes an automatic flight control system 121, an aerial radiation analyzer 122, a memory 123, and a control unit 124.

The automatic flight control system 121 controls the flight of the radiation monitoring UAV 120 so that the radiation monitoring UAV 120 ascends to a measurement altitude every measurement period. Since the automatic flight control system is a common matter in the field of aviation technology, detailed description thereof will be omitted.

The aerial radiation analyzer 122 detects aerial radiation in at least four azimuth directions for each measurement altitude, and analyzes and collects nuclides of the detected aerial radiation in each azimuth direction for each measurement height.

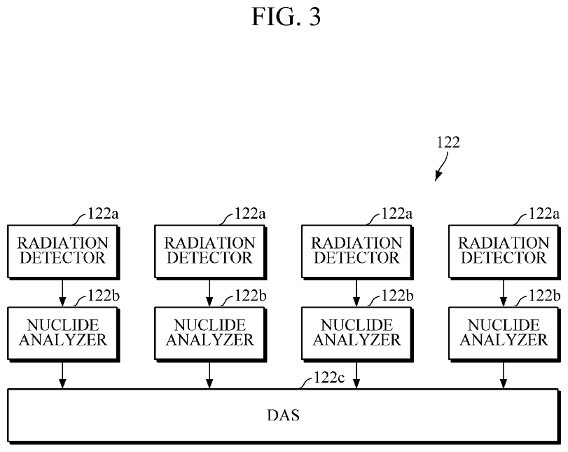

FIG. 3 is a block diagram illustrating a configuration of an aerial radiation analyzer provided in a radiation monitoring UAV of a system for monitoring radiation based on a monitoring post according to an embodiment of the present invention. Referring to FIG. 3, the aerial radiation analyzer 122 includes a plurality of radiation detectors 122a, a plurality of nuclide analyzers 122b, and a data acquisition system (DAS) 122c.

The plurality of radiation detectors 122a are installed in at least four azimuth directions to detect aerial radiation in each azimuth direction for each measurement altitude. For example, a cadmium zinc telluride (CdZnTe (CZT)) detector may be used as the radiation detector 122a.

The CZT detector is a compound semiconductor detector, and due to the high atomic number compared to other semiconductor detectors, has a high density and excellent detection efficiency, providing a benefit of manufacturing the detector in a compact size. However, the present invention is not limited thereto.

Meanwhile, four radiation detectors 122a may each be installed in one of east, west, south, and north directions, or eight radiation detectors 122a may each be installed in one of east, west, south, north, northeast, northwest, southeast, and southwest directions, but the present invention is not limited thereto.

The plurality of nuclide analyzers 122b each analyze nuclides of aerial radiation in a respective one of the azimuth directions for each measurement altitude detected by a respective one of the plurality of radiation detectors 122a. For example, a multi-channel analyzer (MCA) analyzer may be used as the nuclide analyzer 122b.

The MCA analyzer analyzes an energy spectrum of each channel radiation signal output by a respective one of the plurality of radiation detectors 122a, and analyzes a nuclide, that is, a radiation type. However, the present invention is not limited thereto.

The DAS 122c collects results of analyzing nuclides of aerial radiation in each azimuth direction for each measurement altitude which are analyzed by the respective nuclide analyzers 122b.

The memory 123 stores the result of analyzing the nuclides of aerial radiation in each azimuth direction for each measurement altitude output by the aerial radiation analyzer 122. For example, the memory 123 may be a non-volatile memory, such as an electrically erasable PROM (EEPROM) or a flash memory.

The control unit 124 controls drive of the automatic flight control system 121 every measurement period and controls the result of analyzing the nuclides of the aerial radiation in each azimuth direction for each measurement altitude collected by the aerial radiation analyzer 122 to be stored in the memory 123.

For example, the control unit 124 may receive a synchronization signal from the monitoring post 110 every measurement period, and control the radiation monitoring UAV 120 to ascend vertically above the monitoring post 110 to each measurement altitude while automatically maintaining a flight posture during a measurement time.

The automatic flight control system 121, under the control of the control unit 124, allows the radiation monitoring UAV 120 to ascend vertically above the monitoring post 110 to each measurement altitude based on a flight scenario set for each measurement period and automatically maintain the flight posture during the measurement time.

Then, the aerial radiation analyzer 122, under the control of the control unit 124, detects aerial radiation in each azimuth direction for each measurement altitude and analyzes nuclides of the aerial radiation, and stores a result of analyzing the nuclides of the aerial radiation in each azimuth direction at each measurement altitude in the memory 123.

When implemented as described above, the radiation monitoring UAV may perform aerial radiation measurement for each measurement altitude vertically above the monitoring post based on the location in which the monitoring post is installed.

Meanwhile, according to an additional aspect of the invention, the aerial radiation analyzer 122 may further include a plurality of variable units 122d. The plurality of variable units 122d vary the plurality of radiation detectors 122a and the plurality of nuclide analyzers 122b in each azimuth direction to prevent radiation signal interference when detecting radiation in each azimuth direction.

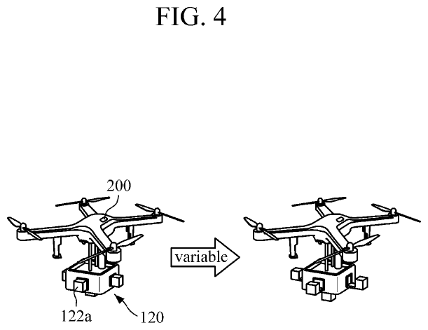

FIG. 4 is a diagram illustrating an example in which an aerial radiation analyzer of a variable structure is mounted on a radiation monitoring UAV. Referring to FIG. 4, the aerial radiation analyzer 122 having a variable structure may be mounted on the radiation monitoring UAV 120 and detect radiation in at least four directions in the air.

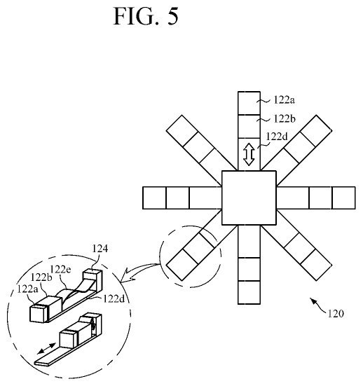

FIG. 5 is a diagram for describing a variable structure of an aerial radiation analyzer provided in a radiation monitoring UAV of a system for monitoring radiation based on a monitoring post according to the present invention. Referring to FIG. 5, it can be seen that eight radiation detectors 122a are each installed in one of east, west, south, north, northeast, northwest, southeast, and southwest directions, and variable in one of the east, west, south, north, northeast, northwest, southeast, and southwest directions.

For example, each of the variable units 122d may include a forward/reverse motor (not shown) rotating in a forward or reverse direction, a guide member (not shown) extending in the azimuth direction or contracted in the opposite direction according to the forward or reverse rotation of the forward/reverse motor, and a fixing member (not shown) for fixing the radiation detector 122a and the nuclide analyzer 122b to the end of the guide member. However, the present invention is not limited thereto.

When the guide member is extended by the driving of the forward/reverse motor in radiation detection, the distances between the radiation detector and nuclide analyzer fixed to the end of the fixing member and the neighboring radiation detectors and nuclide analyzers are widened to minimize the influence of interference of radiation signals incident on the radiation detectors.

When the radiation detection is finished, the guide member is contracted and reduced by the driving of the forward/reverse motor, and the radiation detector and nuclide analyzer fixed to the end of the fixing member become close to the neighboring radiation detectors and nuclide analyzers.

In this case, the control unit 124 may be implemented to control drive of the plurality of variable units 122d to detect radiation in each azimuth direction. For example, the control unit 124, in response to a radiation detection signal generated by a user's wireless manipulation and the like, transmits, to each of the plurality of variable units 122d, a driving control signal for extending and varying the radiation detector 122a and the nuclide analyzer 122b in the respective azimuth direction.

Then, the variable units 122d extend the radiation detectors 122a and the nuclide analyzers 122b in the respective azimuth directions, the radiation detectors 122a detect radiation in the respective azimuth directions, and the nuclide analyzers 122b analyze nuclides of the radiation detected by the respective radiation detectors 122a.

Meanwhile, the control unit 124, in response to generation of a radiation detection ending signal being generated, transmits, to each of the plurality of variable units 122d, a driving control signal for contracting and varying the radiation detector 122a and the nuclide analyzer 122b. Then, the variable units 122d contract the radiation detectors 122a and the nuclide analyzers 122b in the respective azimuth directions.

When implemented as described above, the present invention is implemented to vary the distance between the radiation detectors installed in multiple directions, thereby minimizing the effect of interference of radiation signals incident on the radiation detectors, and thus improving the radiation measurement accuracy.

Meanwhile, according to an additional aspect of the present invention, the radiation detector 122a may be further installed in a downward direction to further detect the radiation in the downward direction. In this case, a nuclide analyzer 122b for analyzing nuclides of radiation detected by the radiation detector 122a installed in the downward direction may be further installed in the downward direction.

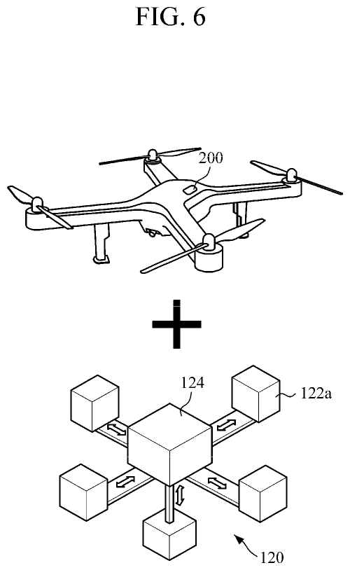

FIG. 6 is a diagram illustrating an aerial radiation analyzer provided in a radiation monitoring UAV of a system for monitoring radiation based on a monitoring post according to another embodiment of the present invention. Referring to FIG. 6, it can be seen that the radiation detector 122a is installed in the downward direction to detect the radiation in the downward direction.

Meanwhile, according to an additional aspect of the invention, the aerial radiation analyzer 122 may further include a plurality of flexible connector cables 122e. The plurality of flexible connector cables 122e are configured to transmit nuclide analysis result signals output from the plurality of nuclide analyzers 122b variable in the respective azimuth directions to the control unit 124 without interruption.

When a fixed connector cable is used, since the plurality of nuclide analyzers 122b are variable in the respective azimuth directions, the plurality of nuclide analyzers 122b may be damaged. To remove this limitation, the plurality of flexible connector cables 122e are used so that the plurality of flexible connector cables 122e are not damaged even when the plurality of nuclide analyzers 120 are varied in the respective azimuth directions, so that the control unit 124 may stably acquire the nuclide analysis result.

Meanwhile, according to an additional aspect of the invention, the radiation monitoring UAV 120 may further include a Global Positioning System (GPS) module 125. The GPS module 125 calculates the current location of the radiation monitoring UAV 120. The GPS module 125 receives GPS satellite signals from a plurality of GPS satellites (not shown) and calculates the current location thereof, which is a common matter known prior to this application, and thus detailed description thereof will be omitted.

In this case, the automatic flight control system 121 may be implemented to control flight of the radiation monitoring UAV 120 such that the radiation monitoring UAV 120 uses the current position calculated by the GPS module 125 to prevent the radiation monitoring UAV 120 from departing from the position vertically above the monitoring post 110.

Meanwhile, the control unit 124 may control the result of analyzing the nuclides of the aerial radiation in each azimuth direction for each measurement altitude to be stored in the memory 123 in association with the current location calculated by the GPS module 125.

When implemented according to the present invention as described above, the radiation monitoring UAV can perform aerial radiation measurement for each measurement altitude vertically above the monitoring post without departing from the location in which the monitoring post is installed, and can store the result of analyzing the nuclides of the aerial radiation in each azimuth direction for each measurement altitude in association with the current location.

Meanwhile, according to an additional aspect of the invention, the radiation monitoring UAV 120 may further include an altimeter 126. The altimeter 126 measures the altitude of the radiation monitoring UAV 120.

In this case, the automatic flight control system 121 uses altitude data measured by the altimeter 126 to control the flight such that the radiation monitoring UAV ascends to the measurement altitude and maintains the measurement altitude for a measurement time.

When implemented according to the present invention as described above, the radiation monitoring UAV can perform aerial radiation measurement while maintaining an accurate measurement altitude at the location in which the monitoring post is installed.

Meanwhile, according to an additional aspect of the invention, the radiation monitoring UAV 120 may further include an azimuth sensor 127. The azimuth sensor 127 measures the azimuth of the radiation monitoring UAV 120.

In this case, the automatic flight control system 121 uses the azimuth measured by the azimuth sensor 127 to control the flight such that the aerial radiation analyzer 122 maintains a constant azimuth direction.

When the radiation monitoring UAV 120 is shaken by wind or the like and the aerial radiation analyzer 122 fluctuates without maintaining a constant azimuth, accurate azimuth radiation measurement is not performable.

The present invention is implemented to measure the azimuth through the azimuth sensor 127, and allow the automatic flight control system 121 to use the azimuth measured by the azimuth sensor 127 to control the flight such that the aerial radiation analyzer 122 maintains a constant azimuth direction, thereby enabling radiation measurement in an accurate azimuth direction.

On the other hand, according to an additional aspect of the invention, the radiation monitoring UAV 120 may further include a first wireless communication unit 128. The first wireless communication unit 128 wirelessly transmits, to the monitoring post 110, the results of analyzing the nuclides of the aerial radiation in each azimuth direction for each measurement altitude stored in the memory 123. For example, the first wireless communication unit 128 may be implemented based on long range (LoRa) having a transmission distance of about several tens of km, but the present invention is not limited thereto.

When implemented according to the present invention as described above, the monitoring post 110 can collect and manage the results of nuclide analysis of aerial radiation in each azimuth direction for each measurement altitude measured by the radiation monitoring UAV 120 flying vertically above the monitoring post 110.

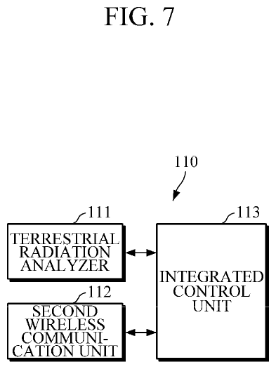

FIG. 7 is a block diagram illustrating a configuration of a monitoring post of a system for monitoring radiation based on a monitoring post according to an embodiment of the present invention. Referring to FIG. 7, the monitoring post 110 according to the embodiment includes a terrestrial radiation analyzer 111, a second wireless communication unit 112, and an integrated control unit 113.

The terrestrial radiation analyzer 111 detects terrestrial radiation every measurement period, and analyzes and collects nuclides of the detected terrestrial radiation. For example, the terrestrial radiation analyzer 111 may include a high pressure ionization chamber (HPIC) type ambient gamma dosimeter installed at a height of 1 m to 2 m from ground level, and a gamma-ray spectrum monitor using a scintillation detector (NaI(Tl)). However, the present invention is not limited thereto.

The second wireless communication unit 112 wirelessly transmits a synchronization signal to the radiation monitoring UAV 120 every measurement period, and wirelessly receives the result of analyzing the nuclides of the aerial radiation in each azimuth direction for each measurement altitude from the radiation monitoring UAV 120. For example, the second wireless communication unit 112 may be implemented based on LoRa having a transmission distance of about several tens of km, but the present invention is not limited thereto.

Here, the synchronization signal is a trigger signal from the monitoring post 110, which measures terrestrial radiation, for instructing the radiation monitoring UAV 120 to perform aerial radiation measurement every measurement period.

The radiation monitoring UAV 120, in response to the synchronization signal being received from the monitoring post 110, flies vertically above the monitoring post 110, detects aerial radiation in each azimuth direction at each measurement altitude, analyzes nuclides of the aerial radiation, and then wirelessly transmits a result of analyzing the nuclides of the aerial radiation in each azimuth direction at each measurement altitude to the monitoring post 110.

Then, the monitoring post 110 wirelessly receives the result of analyzing the nuclides of the aerial radiation in each azimuth direction for each measurement altitude at the location of the monitoring post 110 through the second wireless communication unit 112, and manages the received result of analyzing the nuclides of the aerial radiation.

The integrated control unit 113 integrates and manages a result of analyzing the nuclides of the terrestrial radiation collected by the terrestrial radiation analyzer 111 and a result of analyzing the nuclides of the aerial radiation in each azimuth direction at each measurement altitude received through the second wireless communication unit 112.

Results of measuring terrestrial radiation detected by the monitoring posts 110 installed at a plurality of locations and results of measuring aerial radiation in four azimuth directions at each altitude detected by the radiation monitoring UAVs 120 flying up and down in the air vertically above the respective monitoring posts 110 are collected in real time and analyzed based on meteorological environmental conditions, such as wind direction, wind speed, atmospheric temperature, and precipitation, thereby predicting the movement path and the contaminated area of radioactive materials.

When implemented according to the present invention as described above, aerial radiation measurement for the altitude can be performed in the vertical direction based on the locations in which monitoring posts are installed, so that the movement path and the contaminated area of radioactive materials can be efficiently predicted, and radioactive leakage from the ground surface and radioactive materials that float and move from the outside can be efficiently distinguished, and therefore the risk of radiation exposure can be prepared for in advance.

On the other hand, according to an additional aspect of the invention, the system 100 for monitoring radiation based on a monitoring post may further include a central control server 130. The central control server 130 collects results of detecting terrestrial radiation and results of analyzing nuclides of aerial radiation in each azimuth at each measurement altitude from the plurality of monitoring posts, and analyzes the collected results to estimate a movement path and a contaminated area of radioactive materials.

In this case, the monitoring posts 110 and the central control server 130 may be connected in a wired or wireless manner through a wired network or a mobile communication network between the monitoring posts 110 and the central control server 130, so that the central control server 130 may be implemented to collect results of detecting terrestrial radiation and results of analyzing nuclides of aerial radiation in each azimuth at each measurement altitude from the plurality of monitoring posts 110 installed in a plurality of multiple locations.

The central control server 130 collects results of measuring terrestrial radiation detected by the monitoring posts 110 installed at a plurality of locations, and results of measuring aerial radiation in four azimuth directions at each altitude detected by the radiation monitoring UAVs 120 flying up and down in the air vertically above the respective monitoring posts 110 by measurement time zones, and analyzes the collected results based on meteorological environmental conditions for each measurement time zone, such as wind direction, wind speed, atmospheric temperature, and precipitation, to thereby predict the movement path and the contaminated area of radioactive materials.

The movement path and the contaminated area of radioactive materials predicted by the central control server 130 may be processed and provided over the network, and people may identify information about the movement path and the contamination area of radioactive materials through a television (TV) or a smart phone.

When implemented according to the present invention as described above, aerial radiation measurement for the altitude is performed in the vertical direction based on the locations in which monitoring posts are installed, so that the movement path of and the contaminated area radioactive materials can be efficiently predicted, and radioactive leakage of the ground surface and radioactive materials that float and move from the outside can be efficiently distinguished, and therefore the risk of radiation exposure can be prepared for in advance.

In addition, according to the present invention, early prediction of a nuclear accident is possible through monitoring of a radioactive material movement path, so that radiation exposure of residents may be prevented by issuing an alarm for evacuation of residents.

As is apparent from the above, according to the present invention, aerial radiation measurement for the altitude is performed in the vertical direction based on the locations in which monitoring posts are installed, thereby efficiently predicting the movement path and the contaminated area of radioactive materials, and efficiently distinguishing radioactive leakage from the ground surface and radioactive materials that float and move from the outside, thus preparing for the risk of radiation exposure in advance.

In addition, according to the present invention, since early prediction of a nuclear accident is possible through monitoring of the movement path of radioactive materials, radiation exposure of residents can be prevented by issuing an alarm for evacuation of residents.

In addition, according to the present invention, since the distance between radiation detectors included in an aerial radiation analyzer of a radiation monitoring unmanned aerial vehicle (UAV) and installed in multiple directions are implemented to vary, the effect of interference of radiation signals incident on the radiation detectors can be minimized, and therefore the radiation measurement accuracy can be improved.

Specific embodiments are shown by way of example in the specification and the drawings and are merely intended to aid in the explanation and understanding of the technical spirit of the present invention rather than limiting the scope of the present invention.

Therefore, it should be understood that the scope of various embodiments of the present invention is not defined by the above embodiments but covers all modifications and equivalents derived from the technical spirit of the present invention.

What is claimed is:

1. A system for monitoring radiation based on a monitoring post, the system comprising:
a plurality of monitoring posts each installed at one position of a plurality of positions for monitoring radiation to detect terrestrial radiation at the respective position; and
at least one radiation monitoring unmanned aerial vehicle (UAV) provided for each of the plurality of monitoring posts to detect aerial radiation at each measurement altitude vertically above the monitoring post.

2. The system of claim 1, wherein the radiation monitoring UAV includes:
an automatic flight control system configured to control flight of the radiation monitoring UAV so that the radiation monitoring UAV ascends to the measurement altitude every measurement period;
an aerial radiation analyzer configured to detect aerial radiation in at least four azimuth directions for each measurement altitude and analyze and collect nuclides of the aerial radiation in each of the at least four azimuth directions for each measurement altitude;
a memory configured to store a result of analyzing the nuclides of the aerial radiation in each azimuth direction for each measurement altitude output by the aerial radiation analyzer; and
a control unit configured to control drive of the automatic flight control system every measurement period and control the result of analyzing the nuclides of the aerial radiation in each azimuth direction for each measurement altitude collected by the aerial radiation analyzer to be stored in the memory.

3. The system of claim 2, wherein the radiation monitoring UAV further includes a Global Positioning System (GPS) module configured to calculate a current location,
wherein the automatic flight control system is configured to use the current position calculated by the GPS module to control the flight to prevent the radiation monitoring UAV from departing from a position vertically above the monitoring post.

4. The system of claim 3, wherein the control unit is configured to control the result of analyzing the nuclides of the aerial radiation in each azimuth direction for each measured altitude to be stored in the memory in association with the current position calculated by the GPS module.

5. The system of claim 2, wherein the radiation monitoring UAV further includes an altimeter configured to measure an altitude of the radiation monitoring UAV; and
the automatic flight control system is configured to use altitude data measured by the altimeter to control the flight so that the radiation monitoring UAV ascends to the measurement altitude and maintains the measurement altitude for a measurement time.

6. The system of claim 2, wherein the radiation monitoring UAV further includes an azimuth sensor configured to measure an azimuth, and
the automatic flight control system is configured to use the azimuth measured by the azimuth sensor to control the flight so that the aerial radiation analyzer maintains a constant azimuth direction.

7. The system of claim 2, wherein the aerial radiation analyzer includes:
a plurality of radiation detectors installed in at least four azimuth directions to detect aerial radiation in respective azimuth directions for each measured altitude;
a plurality of nuclide analyzers each configured to analyze nuclides of aerial radiation in a respective one of the at least four azimuth directions for each measurement altitude detected by a respective one of the plurality of radiation detectors; and
a data acquisition system (DAS) configured to collect results of analyzing nuclides of aerial radiation in each of the at least four azimuth directions for each measurement altitude, which are analyzed by each of the plurality of nuclide analyzers.

8. The system of claim 7, wherein the aerial radiation analyzer further includes:
a plurality of variable units configured to vary the plurality of radiation detectors and the plurality of nuclide analyzers in the respective azimuth directions to prevent radiation signal interference when detecting radiation in the respective azimuth directions; and
the control unit is configured to control drive of the plurality of variable units to detect radiation in the respective azimuth directions.

9. The system of claim 8, wherein the radiation detector is further installed in a downward direction to further detect radiation in the downward direction.

10. The system of claim 2, wherein the aerial radiation analyzer further includes a plurality of flexible connector cables each configured to transmit, to the control unit, the result of analyzing the nuclides output from a respective one of a plurality of nuclide analyzers that are variable in respective azimuth directions of the at least four azimuth directions without interruption.

11. The system of claim 2, wherein the radiation monitoring UAV further includes a first wireless communication unit configured to wirelessly transmit the result of analyzing the nuclides of the aerial radiation in each azimuth direction for each measurement altitude stored in the memory.

12. The system of claim 11, wherein the monitoring post includes:
a terrestrial radiation analyzer configured to detect terrestrial radiation every measurement period, analyze nuclides of the detected terrestrial radiation, and collect the analyzed terrestrial radiation;
a second wireless communication unit configured to wirelessly transmit a synchronization signal to the radiation monitoring UAV every measurement period and wirelessly receive the result of analyzing the nuclides of the aerial radiation in each azimuth direction for each measurement altitude from the radiation monitoring UAV; and
an integrated control unit configured to integrate and manage a result of analyzing the nuclides of the terrestrial radiation collected by the terrestrial radiation analyzer and the result of analyzing the nuclides of the aerial radiation in each azimuth direction for each measurement altitude received through the second wireless communication unit.

13. The system of claim 12, further comprising a central control server configured to collect results of detecting terrestrial radiation and results of analyzing nuclides of aerial radiation in each azimuth direction for each measurement altitude from the plurality of monitoring posts, and analyze the collected results to estimate a movement path and a contaminated area of radioactive materials.
